(19) United States
(12) Patent Application Publication
(10) Pub. No.: US 2015/0072921 A1
(43) Pub. Date: Mar. 12, 2015

(54) METHOD FOR THE APPLICATION OF A SUBSTANCE TO ELIMINATE AN INFECTIOUS AGENT LIVING WITHIN AN INSECT VECTOR AS A MEANS OF CONTROL OF THE SPREAD OR ELIMINATION OF DISEASE

(71) Applicants: Steven B. GOLD, Longboat Key, FL (US); John LILLY, Minneapolis, MN (US)

(72) Inventors: Steven B. GOLD, Longboat Key, FL (US); John LILLY, Minneapolis, MN (US)

(21) Appl. No.: 14/543,514

(22) Filed: Nov. 17, 2014

Related U.S. Application Data
(63) Continuation of application No. 13/549,993, filed on Jul. 16, 2012, now abandoned.
(60) Provisional application No. 61/507,860, filed on Jul. 14, 2011.
(60) Provisional application No. 61/512,694, filed on Jul. 28, 2011.

(51) Int. Cl. A01N 37/46; A01N 37/02

(52) U.S. Cl. CPC A01N 37/46; A01N 37/02
USPC 514/2.4; 514/552

(57) ABSTRACT

A method of reducing the spread of disease by inhibiting the growth of or eliminating harmful bacteria which are the cause of the disease in an organism or damage to organic material. The method inhibits bacterial growth in the organism without harming the organism or other organisms in the environment. The method includes formulating an antimicrobial agent that is taken up to the vector organism known to spread disease due to the presence of harmful microbes such as bacteria living in the organism. The antimicrobial agent eradicates and/or inhibits the future growth of the bacteria in the organism, thereby leaving the organism free of the infecting bacteria while not being a poison to the organism.

### CONTINUITY DATA

This application is a continuation of U.S. application Ser. No. 13/549,993, filed on Jul. 16, 2012, and claims priority to Provisional Application No. 61/507,860, filed on Jul. 14, 2011, and Provisional Application No. 61/512,694, filed on Jul. 28, 2011, the disclosures of which are incorporated herein by reference.

### BACKGROUND

1. Technical Field

This application relates to methods for applying a substance to a living organism or to an organic, though not living structure, in either case acting as a host to a vector for harmful or deleterious bacteria, to eradicate or inhibit such bacteria and thereby protect such host from the effects of such bacteria.

2. Description of Related Art

Many infectious agents enter a living plant or animal organism through a wound accidentally suffered by such organism or through the bite of an insect vector carrying such infectious agent, for example in the insect's stomach. One method of dealing with the potential for widespread illness caused by infection communicated in the latter manner involves efforts aimed at the eradication of the insect vector. The wholesale spraying of the synthetic organic insecticide dichlorodiphenyltrichloroethane (DDT) is often cited as the exemplar of the benefit of such action as the eradication of the Aedes aegypti mosquito is recognized as the reason for the dramatic reduction in the presence of Yellow Fever in the world, as that mosquito is the vector for the spread of the virus causing the disease. The adverse unintended consequences of the broad use of DDT has been recognized for several decades and is an effect the present method seeks to avoid.

Citrus greening, also called Huanglongbing or yellow dragon disease, is caused by several species of the genus Candidatus Liberbacter and is primarily spread by two species of psyllid insects—the Asian citrus psyllid, Diaphornia citri and the African citrus psyllid, Trioza erytreae. The Asian citrus psyllid originated in Asia but it is now also found in many parts of the world. In the United States, this psyllid was first detected in Florida in 1998 and is now also found in Florida, Louisiana, Georgia, South Carolina and California. Psyllids nymphs are found on new shoots of citrus trees. As the psyllids feed on the leaves of citrus trees and other host plants they transfer harmful bacteria to the host. Plants and trees affected by citrus greening produce fruit which is unsaleable because of their poor size and quality; ultimately the infection causes the death of the tree.

In addition to infectious agents, many insects may cause damage due to the action of the bacteria they harbor. Termites are an example, exhibiting the textbook version of a symbiotic relationship between the insect which is unable to digest the wood it consumes and the bacteria living in and on the insect which, while able to digest the wood consumed by the termite and providing accessible nutrients to the termite, cannot survive apart from the termite. In this case, dead trees or structural lumber are the host to the termite, which is the vector for its symbiotic bacteria. As used below, the term “infection” is intended to refer to the existence of the deleterious bacteria whether such bacteria is injurious, benign or beneficial to the vector, but is in all cases, injurious to the host of the vector.

### SUMMARY

The present subject matter is directed to methods for reducing the spread of disease, which include steps of formulating a composition comprising the substance having an antimicrobial effect; and applying the composition to the target.

In accord with an embodiment, a method of reducing the spread of disease or elimination of damage to comprises the steps of formulating a composition comprising an antimicrobial agent including but not limited to those selected from the group consisting of a lantibiotic, glycerol monolaurate, and combinations thereof; and applying the composition directly to a target, which target is the host to the vector. As used herein, the term “target host” includes the host of a vector, and “vector” includes carriers of bacteria which are themselves harmful to humans or human endeavor, as for example, agriculture or items or structures composed of organic material, or enable the symbiotic host to itself be harmful. The composition selectively inhibits the growth of or eliminates bacteria, existing in the vector that feeds on the treated target host, and thereby eliminates the cause of the disease or damaging effect of the bacteria.

For example, bacteria that cause disease is present in the gut and mouthparts of an insect vector and the antimicrobial agent has an antimicrobial effect in a sufficient concentration to inhibit bacteria growth or eliminate the bacteria from the vector. The antimicrobial agent has an antimicrobial effect that is benign to the vector and to its host.

The insect may be a psyllid insect and the disease may be citrus greening. The substance is sprayed directly on the citrus plant. When the psyllid consumes leaves previously sprayed with the antimicrobial substance the deleterious bacteria living within the psyllid are exposed to the substance eliminating or reducing the potential for infection of that plant.

These, as well as other components, steps, features, objects, benefits, and advantages, will now become clear from a review of the following detailed description of the illustrative embodiments.

### DETAILED DESCRIPTION OF ILLUSTRATIVE EMBODIMENTS

The present subject matter is generally directed to a method of applying a substance having an antimicrobial effect to the host or potential host of the infected or potentially infected vector without harming the host, the vector or other animals or plants. Such a method involves applying the substance to the foliage, flowers, stems or indirectly to the roots of plants by introducing the substance to the soil, or to the structure of organic non-living items, any of which may host the vector. The substance would be otherwise benign though having the antimicrobial effect resulting from the introduction of the antimicrobial substance to the vector. In this manner the infection carried by the vector would be treated, and the likelihood of non-infected vectors from becoming infected would be reduced. Consequently, the number of subject infected plants, organisms and organic material would be reduced.

The antimicrobial agent would be of the appropriate concentration depending upon the manner of introduction to the microbe, where concentrations would be lowest where the insect vector would be directly exposed to the antimicrobial agent, such as by application on the leaves of a plant and higher concentrations where the antimicrobial agent would be broadcast over the soil for the treatment of plant roots and the microbe being exposed to the antimicrobial agent upon consuming the treated roots or leaves. The antimicrobial agent would further be produced to be combined with a substance which exhibits properties of attraction to the subject insect vector to enhance the drive of the insect to consume the treated plant foliage or roots. An example of a substance added to the antimicrobial agent to enhance the drive of the insect to consume the treated plant foliage or roots would be scented plant extracts or methyl salicylate. The antimicrobial agent would further be produced to include various preparations to increase its persistence and effectiveness through the use of surfactants and other chemical preparations.

In so doing, the vector takes up the substance, which does not directly harm either the animal (including the insect vector), human or plant, but it eradicates and/or inhibits the growth of the infectious agent living within the vector. As used herein, the term ‘eradicate’ means to completely or substantially remove the target from the vector. As used herein, the term ‘inhibit’ means to suppress the initial formation of, or stop the further growth of the harmful microbial. In addition to eliminating the infectious microbe in the initially infected host, should the vector feed on a second or third unprotected animal or plant, the infectious agent, having been eliminated in the stomach or gut of the previously infected vector through its prior feeding on an animal or plant having been treated by the antimicrobial agent, the subsequent victims of the vector would not receive the infection.

As a result, insects, including the vector for the infectious agent and non-vector insects are not harmed by the application and use of the antimicrobial substance. Over time, the presence of the infectious agent would be significantly reduced in the environment generally if not altogether eliminated, with no direct effect on the insect population. In some important cases, however, where bacteria have a symbiotic relationship with the vector, elimination or impairment of that bacteria may have an effect on the vector, as where elimination or impairment of symbiotic bacterial living with termites would cause starvation of those insects.

The antimicrobial agent is not directly harmful to any organism other than microbes. Therefore the antimicrobial can be safely be applied to the vector (such as an insect or animal) carrying the target microbe without being harmful to the vector. At the same time, the antimicrobial agent can effectively inhibit the growth of the harmful microbe. Known insect vectors for damaging bacteria include the Asian citrus psyllid, Diaphornia citri, and the African citrus psyllid Trioza erytreae. In addition, not only is the vector not harmed by the antimicrobial agent, non-vector organisms in the surrounding environment are also not damaged by the antimicrobial agent. Organisms that provide important beneficial roles in the environment, such as honeybees, are not directly affected by the method. Insects and other organisms may, however, be indirectly affected with useful and valuable effect.

For example, it is noted that some insects, while not vectors for disease, are hosts to microbial organisms living in their gut. Perhaps most significantly in this regard are termites which cannot digest wood without the service of the particular microorganisms symbiotically living in the termite's digestive system. While the application of the antimicrobial preparation to wood attractive to termites would not directly kill the termites as is the typical treatment for termite infestation, the elimination of the necessary microbe within the gut of the termite would ultimately cause the collapse of the termite colony by starvation.

Treatment of wood by application of the antimicrobial agent would provide an effective preventive regime against subsequent infestation. Where termite infestation has already occurred, application of the antimicrobial agent to termite-infested wood would be a useful treatment avoiding the use of highly toxic Sulfuryl Fluoride and Methyl Bromide gasses currently the typical treatment in such circumstances. Alternatively, a use for the antimicrobial agent in application to flowers attractive to honeybees would have the effect of eliminating one or several of the parasitic microbial causes of bee colony collapse without affecting the honeybees themselves.

Examples of antimicrobial agents that would be applied directly to the target for which protection against the vector is sought, per the present method, include: antibiotics, antibacterials, antivirals, antifungals, and antiparasitics.

Such a method involves applying the substance directly to the foliage, flowers, stems or roots of plants by introducing the substance to the soil. The substance would be otherwise benign though having the antimicrobial effect resulting from the introduction of the antimicrobial substance to the vector when the vector bites or otherwise feeds on the plant.

The following non-limiting examples serve to provide further appreciation of the application subject matter but are not intended to restrict the effective scope of the invention.

### EXAMPLES

### Example 1

A composition is formulated comprising a lantibiotic, a surfactant and an organic acid. The composition is sprayed directly on the leaves of citrus plants visited by citrus psyllid, Diaphornia citri. The lantibiotic is in sufficient concentration to eradicate the infectious agent in the psyllid.

### Example 2

A composition is formulated comprising glycerol monolaurate, and an organic acid. The composition is sprayed directly on the leaves of citrus plants visited by Asian citrus psyllid, Diaphornia citri. The glycerol monolaurate is in sufficient concentration to eradicate the infectious agent in the psyllid.

### Example 3

A composition is formulated comprising a lantibiotic, glycerol monolaurate, a surfactant and an organic acid. The composition is sprayed directly on leaves of citrus plants visited by Asian citrus psyllid, Diaphornia citri. The lantibiotic and glycerol monolaurate are in sufficient concentration to eradicate the infectious agent in the psyllid.

### Example 4

A composition is formulated comprising a lantibiotic, a surfactant and an organic acid. The composition is sprayed directly on wood attractive to termites. The lantibiotic is in sufficient concentration to eradicate the microbe necessary for the termite's digestion of wood, and thereby cause the collapse of the termite colony by starvation.

The scope of protection is limited solely by the claims that now follow. That scope is intended to be as broad as is reasonably consistent with the language that is used in the claims and to encompass all structural and functional equivalents.

1. A method of reducing the spread of citrus greening, comprising the steps of:
formulating a composition comprising a lantibiotic, glycerol monolaurate or a combination thereof as an antimicrobial agent having antimicrobial effect; and
applying the composition directly to a target host,
wherein the composition selectively inhibits the growth of or eliminates bacteria existing in or on a vector that feeds on the treated target host, and thereby eliminating the causes of the citrus greening or the damaging effect of the bacteria.

2. The method of claim 1, wherein the vector is an insect and the bacteria are present in and spread by the insect.

3. The method of claim 2, wherein the antimicrobial agent inhibits growth of or eliminates the bacteria in the insect.

4. The method of claim 3, wherein the bacteria are in the gut or mouthparts or on the carapace of the insect.

5. The method of claim 3, wherein the antimicrobial agent having an antimicrobial effect is in a sufficient concentration to inhibit growth of the bacteria.

6. The method of claim 1, wherein the composition further comprises an organic acid.

7. The method of claim 1, wherein the vector is a psyllid.

8. The method of claim 1, wherein the composition is sprayed directly on the target host to the infected vector.
